(19) United States
(12) Patent Application Publication
(10) Pub. No.: US 2010/0167229 A1
(43) Pub. Date: Jul. 1, 2010

(54) HANDPIECE FOR APPLYING LASER RADIATION TO A PREDETERMINED AREA

(75) Inventor: Holger Ernst, Ludwigshafen (DE)

Correspondence Address: BACHMAN & LAPOINTE, P.C., 900 CHAPEL STREET, SUITE 1201, NEW HAVEN, CT, 06510, US

(73) Assignee: ELEXXION GMBH, Radolfzell (DE)

(21) Appl. No.: 12/376,506

(22) PCT Filed: Jul. 25, 2007
(86) PCT No.: PCT/EP2007/006590

§ 371 Date: Feb. 5, 2009

(30) Foreign Application Priority Data
Aug. 8, 2006 (DE) 10 2006 037 300.6

(51) Int. Cl. A61C 19/00

(52) U.S. Cl. 433/30; 433/29

(57) ABSTRACT

In a handpiece for applying laser radiation to a predetermined area (4), in particular of the human body, in particular in the area of teeth, wherein a laser beam (3) is guided in a beam path (1) from an inlet to an outlet (2), the handpiece (R) is intended to be surrounded by a protective jacket (7) at least in the area of the outlet (2).

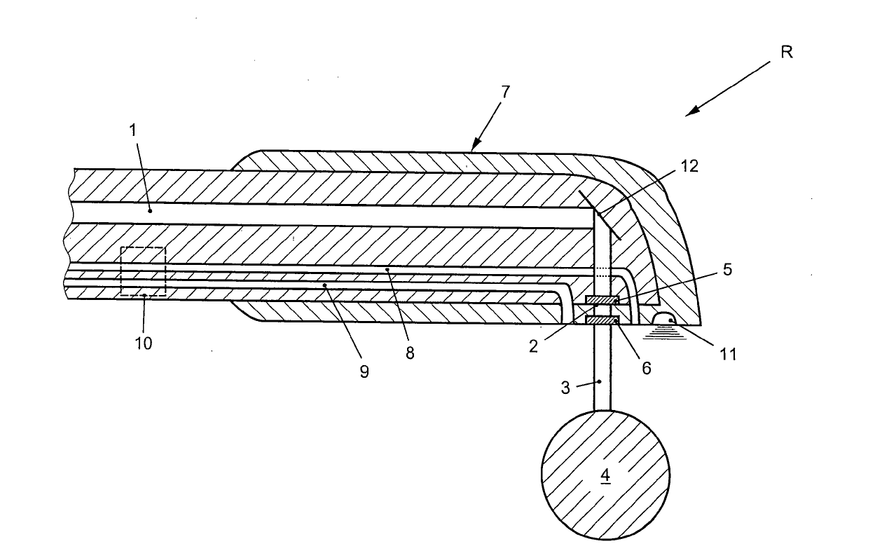

### BACKGROUND OF THE INVENTION

The invention relates to a handpiece for applying laser radiation to a predetermined area, in particular of the human body, in particular in the area of the teeth, wherein a laser beam in a beam path is guided from an entrance to an exit.

The present invention is aimed at a medical or dental handpiece for carrying out treatments which include the use of a laser beam. Such treatments include, inter alia, cutting, evaporating, coagulating, sterilizing, and curative therapies.

An appropriate handpiece is shown, for example, in DE 195 10 939 B4. In this handpiece, a pulsed laser beam is emitted through an exit window in the head of the laser handpiece and is incident in focus on the area to be treated.

In such medical handpieces, the parts which come into contact with the patient have to either be sterilizable or be single-use components. It is for this reason that handpieces for different applications are made from a plurality of parts which can be separated by the medical practitioner or the medical practitioner's assistant. The parts which come into contact with the patient are then sterilized. In the case of handpieces for laser application, this is not necessarily possible in a simple fashion as a result of the arrangement of the optics. Optical components of the beam path are at least in part open at the user and can be contaminated. Contaminations lead to damage and destruction of the optical components and hence to the failure of the laser transmission system. Moreover, critical optical components are included in the sterilization process, which makes further damage possible, either indirectly, via possible condensation of water on optical elements, or directly.

It is the object of the present invention to protect such a handpiece from contaminations and damage, and to make the parts which come into contact with the patient autoclavable.

### SUMMARY OF THE INVENTION

The object is achieved by virtue of the fact that the handpiece is surrounded by a protective cladding, at least in the area of the exit.

This generates a closed area in the handpiece which is protected against dirt which the user cannot open when used properly and hence the user cannot contaminate it either. All critical optical elements are contained therein. The protective cladding according to the invention surrounds this area which comes into contact with the patient, as a result of which biological contamination is precluded. Preferably this protective cladding can be separated from the handpiece and is independently autoclavable.

The exit of the beam path in the handpiece is closed off by a window. This window is a window which is transparent to the laser beam. By way of example, it is composed of sapphire.

The protective cladding also has a protective window in the area of the window of the handpiece, which likewise is preferably composed of sapphire. This ensures that the laser beam can emerge through both the window and the protective window, and be incident on the area to be treated.

Preferably there is also a pipe for a gas and/or also a pipe for a liquid in the handpiece. It is also feasible that a pipe for a gas/liquid mixture is provided. However, the gas and the liquid can also be mixed in a mixing chamber in the handpiece itself. In this fashion it is possible to generate an air-water spray, for example. There are a number of possibilities for guiding the pipe. By way of example, it is possible for the pipes or a pipe to open out at appropriate nozzles in the protective cladding, downstream of the mixing chamber. The spray can then be inserted into the treatment area through these nozzles. Guiding in the protective cladding is also feasible, with the pipes and/or mixing chambers or nozzles being located in the protective cladding. Furthermore, external guiding is possible; in this case the mixing chamber and nozzle are arranged either in the protective cladding or likewise externally.

Incidentally, laser radiation with a wavelength in the region of 3 μm +/−0.5 μm is preferred. The guided laser beam is a beam from an erbium laser.

If necessary, the laser beam in the beam path can be deflected by an arbitrary optical element. By way of example, it is possible to carry out a deflection by about 85° to 95°.

It is preferable for the laser beam to be generated in a laser system which is spatially separated from the handpiece and to be inserted into the handpiece by means of an optical transmission line. The optical transmission line is a combination of optical deflection elements and free-beam sections. The optical transmission line can be an articulated mirror arm. However, the optical transmission line can also be an optical waveguide, a liquid optical waveguide or an optical fiber. However, the idea that the laser beam is generated in a laser system which is not spatially separated from the handpiece is also covered by the invention.

In a preferred exemplary embodiment, at least one part of the handpiece should be rotatable about the longitudinal axis of the handpiece. This improves the handling of the handpiece.

The handpiece according to the invention lends itself in particular to the treatment of biological tissue. It is to be used particularly in the field of medicine, and here in the field of dentistry. Should it be necessary, it is also possible to arrange a luminous element on the handpiece, which illuminates the areas to be treated. A number of possibilities are feasible for arranging the luminous element and the corresponding electric lines. By way of example, it is possible that the electric line and the light element are located in the handpiece itself, with a transparent window being provided in the protective cladding. However, the luminous element can also be provided in the protective cladding, with connections to electric lines in the handpiece being provided in this case. It is furthermore possible for the electric lines to be guided externally and for the luminous element to be located in the protective cladding or externally.

### BRIEF DESCRIPTION OF THE DRAWING

Further advantages, features, and details of the invention emerge from the following description of preferred exemplary embodiments, and from the drawing which in its only FIGURE schematically illustrates a partial longitudinal cut through a handpiece R according to the invention.

### DETAILED DESCRIPTION

Only a front area of a for example medical handpiece R is illustrated, and it is traversed by a beam path 1. This beam path 1 has an entrance not shown in any more detail, and an exit 2 through which a laser beam 3 is targeted onto an area 4 to be treated. In the process, the laser beam 3 is deflected in the beam path 1 by means of a mirror 12.

A window 5 transparent to the laser beam, preferably composed of sapphire, is located in the exit 2. A protective window 6, likewise composed of sapphire, in a protective cladding 7 is assigned to this sapphire window 5 so that the laser beam 3 has to pass through both the window 5 and the protective window 6. The window or protective window does not have to be planar; it can also be designed in a conical shape or in the form of a prism. It only has to transmit the laser beam.

The protective cladding 7 surrounds the front area of the handpiece R such that the beam path 1 is protected against contamination, and such that the handpiece is autoclavable in this area. Penetration by external dust and water is avoided. For this purpose, the protective cladding 7 is composed of an appropriate material which surrounds the handpiece and which can be removed from the handpiece.

Both an inlet pipe 8 for a gas and an inlet pipe 9 for a liquid are provided in the handpiece R in addition to the beam path 1. Furthermore, a mixing chamber 10, in which the gas can be mixed with the liquid, is indicated by the dashed lines.

Moreover, a luminous element 11 is provided at the tip of the handpiece R in the protective cladding 7, by means of which the area 4 can be illuminated.

1-22. (canceled)

23. A handpiece for applying laser radiation to the area of teeth, comprising:
a first part having a laser beam inlet, a laser beam exit and a beam path for guiding a laser beam from the laser beam inlet to the laser beam exit; and
a second part surrounding at least a portion of the first part defining the laser beam exit, wherein the second part comprises a protective cladding.

24. The handpiece as claimed in claim 23, wherein the protective cladding is separable from the first part.

25. The handpiece as claimed in claim 23, wherein the protective cladding is autoclavable.

26. The handpiece as claimed in claim 23, wherein the laser beam exit includes a window which is transparent to the laser beam.

27. The handpiece as claimed in claim 26, wherein the window is composed of sapphire.

28. The handpiece as claimed in claim 26, wherein the second part includes a protective window in the area of the window of the laser beam exit.

29. The handpiece as claimed in claim 28, wherein the protective window in the second part is transparent to the laser beam.

30. The handpiece as claimed in claim 29, wherein the protective window in the second part is composed of sapphire.

31. The handpiece as claimed in claim 23, wherein the first part further comprises a pipe for gas and a pipe for liquid.

32. The handpiece as claimed in claim 23, wherein the first part further comprises a pipe for a gas/liquid mixture.

33. The handpiece as claimed in claim 31 or 32, wherein the liquid comprises in part water.

34. The handpiece as claimed in claim 32, wherein the first part further comprises a mixing chamber.

35. The handpiece as claimed in claim 32, wherein the gas/liquid mixture is at least in part composed of the surrounding air.

36. The handpiece as claimed in claim 32, wherein the gas/liquid mixture is an air-water spray.

37. The handpiece as claimed in claim 23, wherein the beam path is deflected at an angle of between 85° to 94°.

38. The handpiece as claimed in claim 23, wherein the laser beam is generated in a laser system which is spatially separated from the handpiece and the laser beam connects to the handpiece by means of an optical transmission line.

39. The handpiece as claimed in claim 38, wherein the optical transmission line is a combination of optical deflection elements and free-beam sections.

40. The handpiece as claimed in claim 38, wherein the optical transmission line is an articulated mirror arm.

41. The handpiece as claimed in claim 38, wherein the optical transmission line is an optically high conductor.

42. The handpiece as claimed in claim 38, wherein the optical transmission line is a liquid optical waveguide.

43. The handpiece as claimed in claim 38, wherein the optical transmission line is an optical fiber.

44. The handpiece as claimed in claim 23, wherein a light element is assigned to the exit.
